(19) United States
(12) Patent Application Publication
(10) Pub. No.: US 2015/0353143 A1
(43) Pub. Date: Dec. 10, 2015

(54) FENDER ASSEMBLY FOR WHEEL TRACTOR-SCRAPERS

(71) Applicant: Caterpillar Inc., Peoria, IL (US)

(72) Inventor: Srinivasan Bojan, Chennai (IN)

(21) Appl. No.: 14/827,323

(22) Filed: Aug. 15, 2015

(51) Int. Cl. B62D 25/18

(52) U.S. Cl. CPC B62D 25/184

(57) ABSTRACT

A fender assembly of a machine includes a frame and at least one tire. The fender assembly has a primary fender portion connected to the frame, and defines a first surface and a second surface. The first surface defines a gap with a first interface. The first fender portion is based on a rigid material. A secondary fender portion with an interfacial surface and tire-facing surface is contiguously connected with the primary fender portion, and extends into a gap between a second interface and the tire, while being restricted against the second interface. The secondary fender portion is based on a non-rigid material. An intermediate support assembly is connected to the tire-facing surface to support the secondary fender portion to the frame. The intermediate support assembly imparts a clearance with the tire to direct debris at the tire-facing surface, and is removable along a width and outwardly to the machine.

### TECHNICAL FIELD

The present disclosure relates generally to a fender assembly for a machine. More specifically, the present disclosure relates to a laterally attachable fender assembly that defines sufficient clearances relative to the machine and a tire of the machine.

### BACKGROUND

Construction machines, such as wheel tractor scrapers, that perform earthmoving operations are frequently subjected to rigorous operational conditions over considerably rugged terrains. Such terrains mostly include moist ground or sticky soil. As a tire of the construction machine rolls over such terrains, sticky soil may bond to the tire, in turn picking up the underlying debris and sticky clay. A continued tire roll causes a soil-debris mixture to be carried into a clearance space between the tire and a fender assembly of the construction machine. This leads to a situation commonly referred to as a mud build-up or simply a build-up on the tire. If left unattended, such a build-up generally accumulates in relatively large volumes within the clearance space. A prolonged presence of build-up within such clearances may cause rusting, loss of paint, deterioration, and may even cause malfunction of certain components, accommodated and routed therein. The fender assembly generally endures the most in such conditions. On several occasions, tire build-up is mixed with trash, sharp stones, hard gravel, and the like, which may severely deform the structure of the overlying fender. Therefore, in due time, it is generally required to disassemble the fender assembly for repairs and replacement.

Conventionally, a disassembly process of the fender assembly involves the removal of one or more of the surrounding components of the machine, such as, a hydraulic tank, cab guard, etc. Therefore, present day removal practice is cumbersome, time consuming, and adds high downtime for machine operation.

U.S. Pat. No. 4,706,980 A relates to a quarter-fender assembly for a truck. A mounting assembly for the quarter-fender assembly is disclosed that positions the quarter fender assembly to a frame of the truck. However, a focus of the application is on lessening the number of components applied, such as brackets and mounting tubes. Moreover, no solution is provided to ease a disassembly process of the quarter fender assembly from the frame of the truck.

Accordingly, the system and method of the present disclosure solves one or more problems set forth above and other problems in the art.

### SUMMARY OF THE INVENTION

Various aspects of the present disclosure describe a fender assembly of a machine. The machine includes a frame and at least one tire. The fender assembly includes a primary fender portion with a first surface and a second surface. The first surface defines a gap between the primary fender portion and a first interface. The primary fender portion is based on a rigid material and is connected to the frame. Further, a secondary fender portion with an interfacial surface and tire-facing surface is contiguously connected with the primary fender portion. The secondary fender portion extends into a gap between a second interface and the tire, and being restricted against the second interface. The secondary fender portion is based on a non-rigid material. Additionally, an intermediate support assembly is connected to the tire-facing surface and supports the secondary fender portion to the frame. The intermediate support assembly imparts a clearance to the secondary fender portion relative to the tire so as to direct debris building up on the tire-facing surface. The secondary fender portion is removable along a width and outwardly to the machine.

### BRIEF DESCRIPTION OF THE DRAWINGS

FIG. 1 is a left hand side view of an exemplary scraper machine that includes a modular fender assembly, in accordance with the concepts of the present disclosure;

FIG. 2 is a pictorial view of a portion of machine illustrating a left hand side front wheel along with the fender assembly of FIG. 1, where inner configurations and various assemblies that support the fender assembly is shown, in accordance with the concepts of the present disclosure;

FIG. 3 is a pictorial view of the machine of FIG. 2, illustrating an exemplary process of removal of a secondary fender portion from the fender assembly of FIG. 2, in accordance with the concepts of the present disclosure;

FIG. 4 is an exploded view of the fender assembly of FIG. 2, in accordance with the concepts of the present disclosure; and

FIG. 5 is an exemplary side view of the fender assembly of FIG. 1, depicted relative to a deployment alongside the tire of the scraper machine.

### DETAILED DESCRIPTION

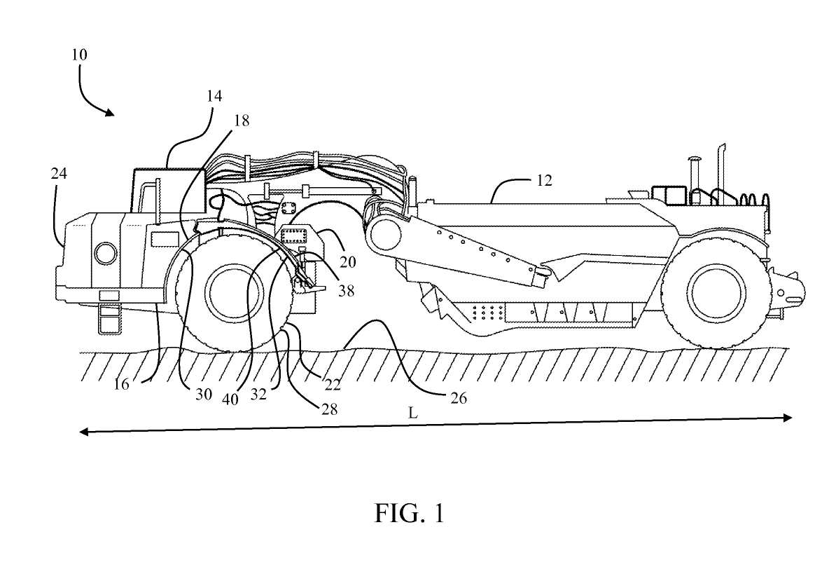

Referring to FIG. 1, there is shown an exemplary construction machine 10, which is referred to as a machine 10, hereinafter. The machine 10 is a wheeled tractor scraper or a wheeled scraper machine. However, an application of the present disclosure may be contemplated to other machines, such as wheeled excavators, wheeled loaders, and the like. An extension of this application to off-highway trucks, articulated trucks, haul trucks, large mining trucks (LMT), and other such wheeled machines, is also envisioned. The machine 10 may be electrically or mechanically operated. The machine 10 includes a scraper bowl 12, an operator cab 14, a frame 16, a fender assembly 18 connected to the frame 16, a hydraulic tank 20, and a tire 22, positioned underneath the fender assembly 18. The frame 16 also supports an engine compartment 24.

The scraper bowl 12 is used to carry payload material scraped from a ground surface 26. To facilitate such loading, the scraper bowl 12 may include a cutting edge (not shown). Further, the scraper bowl 12 may be oriented into different positions. For example, a raising and lowering action of the scraper bowl 12 may be contemplated. Those actions may be realized by use of hydraulic lifts (not shown) or by other electronically controllable mechanisms for which hydraulic fluid within the hydraulic tank 20 may be applied. To accomplish various other applications, the machine may include several loading gears, aprons, and implements (for example, elevators and augers), as well as moveable ejectors, blades, and scrapers (not shown), for which hydraulic fluid from the hydraulic tank may be applied for activation.

The frame 16 may be a machine chassis, and supports the scraper bowl 12, the fender assembly 18, the operator cab 14, the engine compartment 24, and other portions of the machine 10. The frame 16 also operably accommodates the tire 22. Various configurations of the frame 16 may be contemplated, such as those with a ladder frame construction, or a monocoque structure.

The operator cab 14 provides a location from where an operator may control one or more aspects of the machine 10. As an example, the control of the movement of the machine 10, movement of the aprons, implements (not shown), and the like, may be controlled from within the operator cab 14. The operator cab 14 also defines a first interface relative to the fender assembly 18.

The hydraulic tank 20 stores a hydraulic fluid required for use in one or more applications of the machine 10. For example, a use with the implements of machine as already noted. The hydraulic tank 20 is positioned at a position generally higher along a vertical or a height of the machine 10. In an embodiment, at least a portion of the fender assembly 18 is restricted against the hydraulic tank 20, at least in a direction defined towards the hydraulic tank 20. As with the deployment of the operator cab 14, the hydraulic tank 20 defines a second interface relative to the fender assembly 18.

The tire 22 is positioned under the fender assembly 18 in a manner known to define a clearance space between the tire 22 and the fender assembly 18. The tire 22 includes a tire contact surface 28, which contacts the ground surface 26 during applications. Further, the tire 22 may be made of rubber, nylon, and/or other similar materials.

Referring to FIGS. 1, 2 and 3, the fender assembly 18 is generally divided into two components—namely a primary fender portion 30 and a secondary fender portion 32. This division is in order to ease an assembly and a disassembly of the fender assembly 18 from the machine 10, when required. Moreover, this method of assembly also complements the surrounding components attached to the machine 10, as complemented by conventional fender assemblies. An arrangement of the fender assembly 18 relative to the machine 10 involves a sufficient clearance defined between the fender assembly 18 and the tire 22, to accommodate a mud build-up on a tire contact surface 28 during operation. Structural configurations of this aspect are further discussed below.

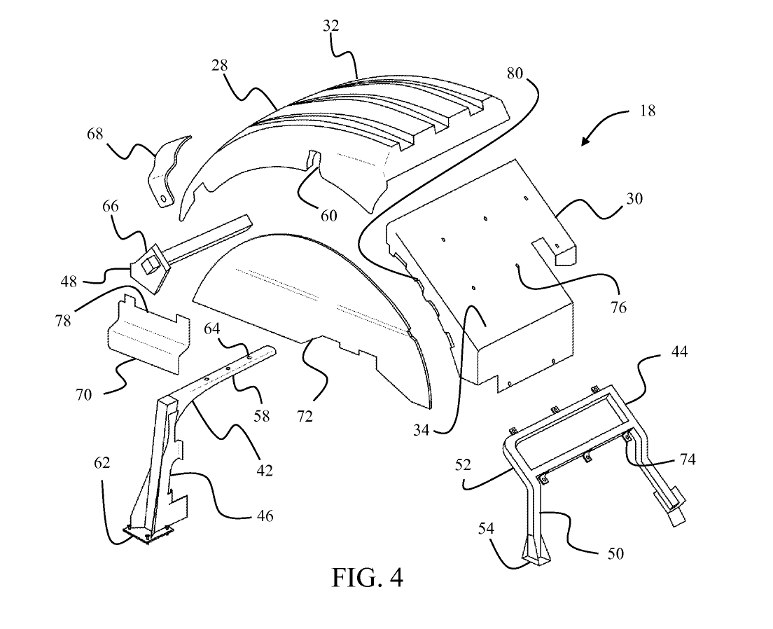

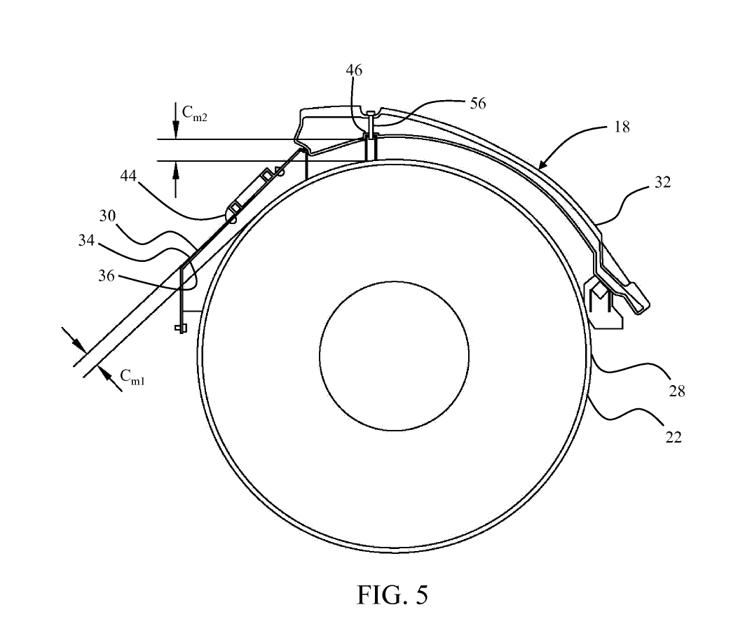

The primary fender portion 30 is positioned in a gap (best shown FIG. 1 and FIG. 5) defined between the tire 22 and the operator cab 14. As illustrated in FIG. 5, the primary fender portion 30 includes a first surface 34 and a second surface 36. The first surface 34 is directed towards the operator cab 14 (FIG. 1), while the second surface 36 is directed towards the tire 22. The primary fender portion 30 is made of a rigid material, such as a sheet metal that may be formed and bent to shape to provide easy assembly of the fender assembly 18 with the machine 10, and to complement the tire 22. The primary fender portion 30 includes a zigzag profile 80 (FIG. 4) to mate with a portion of a shield plate 72 (FIG. 4) of the fender assembly 18.

The secondary fender portion 32 is a secondary fender portion with an interfacial surface 38 and tire-facing surface 40. The interfacial surface 38 is generally an outwardly accessible and viewable surface, while the tire-facing surface 40 is the secondary fender portion's 32 underside that is directed towards the tire 22 and may not be readily viewable or accessible from the outside. The secondary fender portion 32 is contiguously connected with the primary fender portion 30 and extends into a gap defined between the hydraulic tank 20 and the tire 22. In that manner, the secondary fender portion 32 is restricted against the hydraulic tank 20. However, this restriction is substantially along a height of the machine 10. The secondary fender portion 32 is based on a non-rigid material so as to be relatively flexible and lightweight to be less complex during a disassembly.

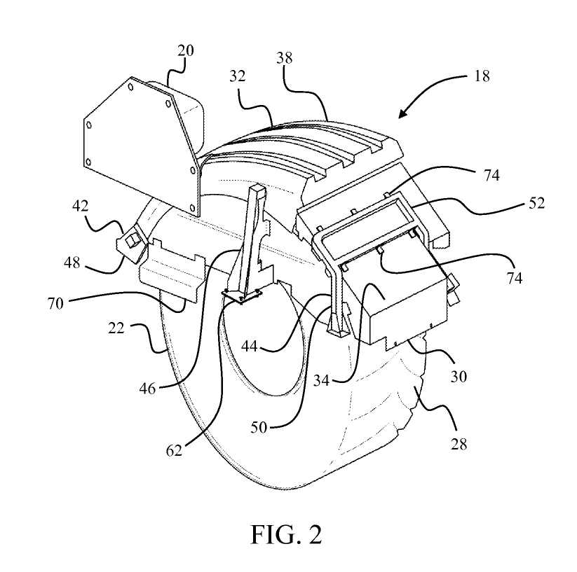

Referring to FIGS. 2, 3, and 4, the fender assembly 18 includes a support assembly 42 to support the fender assembly 18 to the frame 16. The support assembly 42 includes multiple sub-assemblies, namely—a first support assembly 44, an intermediate support assembly 46, and a second support assembly 48.

The first support assembly 44 is adapted to support the primary fender portion 30. The first support assembly 44 includes an elongated member 50 connected to an interlinked structure 52. The interlinked structure 52 is rectangular shaped, so as to be connectable to the first surface 34 of the primary fender portion 30. Alternate shapes of the interlinked structure 52 may be contemplated by which the primary fender portion 30 may be independently supported by the first support assembly 44. As an example, the shape may be triangular or polygonal in profile. The elongated member 50 has a first support end 54 connected to the frame 16 (FIG. 1), while having the interlinked structure 52 extended outwards from the machine 10 and the frame 16. By way of this arrangement, the first support assembly 44 inflexibly supports the primary fender portion 30 to the frame 16 without the need to have an additional support structure. The general outward deployment of the first support assembly 44 relative to the frame 16 in is a direction lateral to a length, L (FIG. 1), of the machine 10 and generally parallel to the ground surface 26. Connections of the first support assembly 44 relative to the primary fender portion 30 may include bolted or threaded fasteners 56 (FIG. 5), so as to make it relatively easy for an operator to quickly loosen the connections and remove the secondary fender portion 32, if there is a need. As shown, apertures 74 and 76 are respectively provided within the interlinked structure 52 and the first surface 34 so as to facilitate an inflexible connection between the first support assembly 44 and the primary fender portion 30 by threaded fasteners, for example. Notably, this connection feature provides a direct connection interface between the first support assembly 44 and the primary fender portion 30.

The intermediate support assembly 46 is adapted to support the secondary fender portion 32. The intermediate support assembly 46 includes a number of components, which imparts the intermediate support assembly 46 with an L-shaped profile. More particularly, the intermediate support assembly 46 includes an L-shaped member, with stiffeners (not shown) in between the angled profile of the L-shaped member to provide rigidity to the deployment of the secondary fender portion 32 with the frame 16. A position of the intermediate support assembly 46 is substantially midway to a disposal of the first support assembly 44 and the second support assembly 48. In that way, a weight of the fender assembly 18 is substantially evenly distributed across an associated portion of the frame 16. The intermediate support assembly 46 includes an extension member 58 (FIG. 4), which passes through a side opening 60 formed in the secondary fender portion 32 and engages with the tire-facing surface 40 of the secondary fender portion 32. The intermediate support assembly 46 is connected to the frame 16 at an intermediate end 62. However, it is noticeable that the frame 16 is not depicted in FIGS. 2, 3, and 4, but solely, in FIG. 1, for clarity, ease in understanding, and reference. Similar to the direct connection of the first support assembly 44 by bolted and threaded connections, it is contemplated that connections of the intermediate support assembly 46 to the tire-facing surface 40 is attained directly and threadably or as a bolted configuration (FIG. 5). In so doing, the intermediate support assembly 46 is able to be directly fastened and loosened relative to the secondary fender portion 32 through apertures 64 (FIG. 4) that are structured within the intermediate support assembly 46.

The second support assembly 48 is also adapted to support the secondary fender portion 32. The second support assembly 48 is similar to the intermediate support assembly 46. To this end, the second support assembly 48 is connected to the frame 16 at a second support end 66 and extends outwardly relatively laterally to the length, L, (FIG. 1) of the machine 10 to support the secondary fender portion 32 at the tire-facing surface 40. Connections of the second support assembly 48 to the secondary fender portion 32 are generally similar to the connections described for the first support assembly 44 and the intermediate support assembly 46. Therefore, bolted or threaded connections may be contemplated, and which provide direct connectively and relative ease in assembly and disassembly when a removal or a replacement of the secondary fender portion 32 is required.

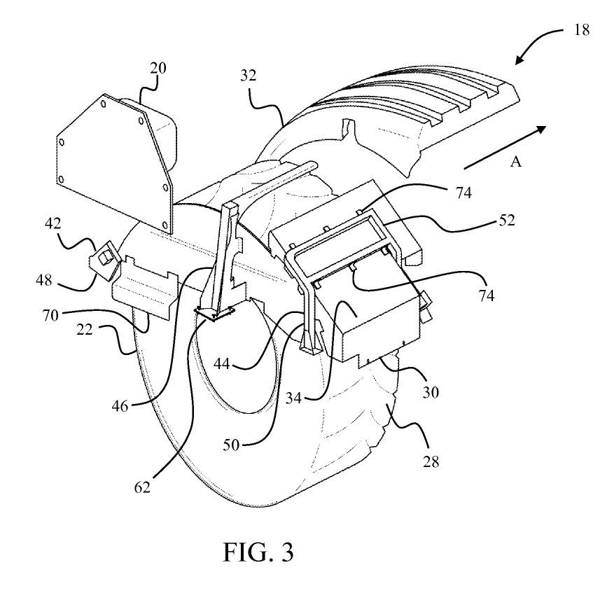

When the intermediate support assembly 46 and the second support assembly 48 are assembled and applied to affix the secondary fender portion 32 to the frame 16, sufficient rigidity is provided to the secondary fender portion 32 so as to be immovably attached to the frame 16. However, it remains pertinent that the substantially linearly configured surfaces of the tire-facing surface 40 facilitates the establishment of direct connectively between the support assembly 42 and the primary fender portion 30 and the secondary fender portion 32. Accordingly, a removal of the secondary fender portion 32 from the frame 16 and the machine 10 may be facilitated substantially laterally to the machine 10. An exemplary direction of removal is depicted by arrow, A, (FIG. 3).

Referring to FIG. 4, an exploded view of the fender assembly 18 provides illustrious references to additional features and components of the fender assembly 18. In the depicted embodiment, there is included a bracket 68 and a metallic baffle 70. The bracket 68 is adapted to support the shield plate 72 of the fender assembly 18 to the secondary fender portion 32. Further, the metallic baffle 70 is set to support the shield plate 72 of the fender assembly 18 to the frame 16. The bracket 68 includes an undulating or a zigzag profile 78 that effectively accommodates a portion of the shield plate 72 without the need to have a fixation between the shield plate 72 and the bracket 68.

Referring to FIG. 5, there is shown a side profile of the fender assembly 18 with the tire 22 so as to illustrate a clearance attained by the fender assembly 18, according to aspects of the present disclosure. This clearance is attained by the negation of the sleeves that were conventionally applied. However, it needs to be noted that this clearance value and a range quoted may change at least minimally in real life usage and applications, and, therefore, the range of clearance need to be seen as being are purely exemplary in nature. Moreover, the ranges cited here are more applicable to situations when the machine 10 is stationery over a relatively flat ground surface 26, since during a machine movement, this range may change.

Exemplarily, a clearance Cₘ₁ attained by the first support assembly 44 with the tire contact surface 28 is in the range of 66 millimeters (mm) to 69 mm. A clearance Cₘ₂ attained by the intermediate support assembly 46 with the tire contact surface 28 is in the range of 100 mm to 104 mm.

### INDUSTRIAL APPLICABILITY

Described below is an exemplary sequence of events for the removal of the secondary fender portion 32. However, it may be well suited for one to apply a similar sequence of events to remove the primary fender portion 30 as well.

As the machine 10 operates over rigorous terrains, sticky soil bonds to the tire contact surface 28 and moves into a clearance defined between the tire 22 and the fender assembly 18. A prolonged presence of the sticky soil leads to deterioration and degradation of the fender assembly 18. Moreover, at times, a movement of the machine 10 is severely affected as well. Therefore, a removal of the build-up around the tire 22 is performed by removing the secondary fender portion 32.

During a disassembly of the secondary fender portion 32, an operator first removes the bolted or threaded connections so as to loosen the secondary fender portion from the intermediate support assembly 46. Thereafter, the operator loosens the connections set between the second support assembly 48 and the secondary fender portion 32. Once these connections are loosened, the operator pulls out the secondary fender portion 32 from the fender assembly 18. This pull-out action is performed in a lateral direction to the length of the machine 10 or along a width (direction, A, FIG. 3) of the machine 10. In so doing, it is easy for an operator to perform quick repairs and replacement operations on the fender assembly 18. Moreover, as this sequence negates any requirement to have the hydraulic tank 20 removed, the task is free from complexity and extra effort.

By avoiding the conventional sleeve design approach to affix the fender assembly 18 to the support assembly 42, a two-fold advantage is obtained. First, a sufficient clearance is attained so as to effectively direct debris building up on the tire-facing surface 40, and second, that the secondary fender portion 32 is removable along a width or laterally and outwardly to the machine 10. By way of this arrangement, a removal of the hydraulic tank 20 to perform a disassembly of the fender assembly 18 is no longer required. Moreover, aspects of the present disclosure are applicable to fender assemblies of other machines as well. Therefore, clearance values between the fender assembly 18 and the tire 22 may change depending upon requirements of a structural profile, shape and size of fender assemblies applied elsewhere.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A fender assembly of a machine, the machine including a frame and at least one tire, the fender assembly comprising:
a primary fender portion having a first surface and a second surface, the first surface defining a gap between the primary fender portion and a first interface, the primary fender portion being based on a rigid material and being connected to the frame;
a secondary fender portion with an interfacial surface and tire-facing surface and being contiguously connected with the primary fender portion, the secondary fender portion extending into a gap between a second interface and the at least one tire, and being restricted against the second interface, wherein the secondary fender portion is based on a non-rigid material;
an intermediate support assembly to be connected to the tire-facing surface and supporting the secondary fender portion to the frame,
wherein the intermediate support assembly imparts a clearance to the secondary fender portion relative to the at least one tire to direct debris building up on the tire-facing surface,
wherein the secondary fender portion is removable along a width and outwardly to the machine.
